(19) United States
(12) Patent Application Publication
(10) Pub. No.: US 2006/0120920 A1
(43) Pub. Date: Jun. 8, 2006

(54) Hydrogen or helium sensor

(75) Inventor: David M. Rue, Chicago, IL (US)

Correspondence Address: MARK E. FEJER;GAS TECHNOLOGY INSTITUTE, 1700 SOUTH MOUNT PROSPECT ROAD, DES PLAINES, IL, 60018, US

(73) Assignee: GAS TECHNOLOGY INSTITUTE

(21) Appl. No.: 11/005,540

(22) Filed: Dec. 6, 2004

(51) Int. Cl. G01N 31/22

(52) U.S. Cl. 422/58

(57) ABSTRACT

An apparatus for measuring a concentration of hydrogen, helium or neon in a bulk gas mixture comprising the gas. The apparatus includes a membrane-substrate assembly of a porous, chemically inert substrate material and a chemically inert permeable membrane, a non-permeable housing disposed around the membrane-substrate assembly such that only an active portion of the chemically inert permeable membrane is exposed directly to the bulk gas mixture during operation of the apparatus. The apparatus further includes a vacuum pump for evacuating the housing in between uses of the apparatus, at least one pressure measuring device for measuring the pressure of gas diffusing through the membrane-substrate assembly into the housing, at least one temperature controller for controlling temperature within the housing, at least one pressure sensor for measuring the bulk gas pressure, and at least one temperature sensor for measuring the bulk gas temperature.

### BACKGROUND OF THE INVENTION

1. Field of the Invention

This invention relates to a method and apparatus for measuring the concentration of hydrogen gas in any gas mixture in which no helium gas and neon gas are present. This invention relates to a method and apparatus for measuring the concentration of helium gas in any gas mixture in which no hydrogen gas and neon gas are present. And, finally, this invention relates to a method and apparatus for measuring the concentration of neon gas in any gas mixture in which no helium gas and hydrogen gas are present.

The measurement of hydrogen concentrations in a gas mixture, particularly at low levels, is subject to numerous difficulties including interference from other gases present in the mixture, deterioration of the sensor by exposure to certain gases, and short sensor lifetimes caused by physical or chemical deterioration of the sensor components. Known methods and devices for determining the concentration of hydrogen in a gas mixture include laboratory techniques such as gas chromatography and mass spectroscopy. Other approaches include metal hydride based techniques and electrochemical techniques in which hydrogen is dissociated in passing through a transport membrane. However, such techniques rely upon the use of costly materials and sensor devices.

### SUMMARY OF THE INVENTION

Accordingly, it is one object of this invention to provide a method and apparatus for measuring hydrogen concentration in a gas mixture that is reliable and low-cost.

It is one object of this invention to provide a method and apparatus for measuring hydrogen concentration in a gas mixture suitable for making quantitative determinations of any hydrogen concentration from 1 ppm up to 100%.

It is still another object of this invention to provide a method and apparatus for measuring hydrogen concentration in a gas mixture which is not subject to interference from other gases present in the gas mixture.

It is still a further object of this invention to provide a method and apparatus for measuring hydrogen concentration in a gas mixture which addresses the issue of sensor deterioration when exposed to certain gases.

It is yet a further object of this invention to provide a method and apparatus for measuring hydrogen concentration in a gas mixture which overcomes the short sensor lifetimes caused by physical or chemical deterioration of conventional sensor components.

These and other objects of this invention are addressed by an apparatus comprising a membrane-substrate assembly comprising a porous, chemically inert substrate material and a chemically inert permeable membrane having a hydrogen gas diffusion rate higher than the diffusion rate of the remaining bulk gas mixture components, which membrane is secured to the porous substrate material. A housing constructed of at least one non-permeable wall is disposed around the membrane-substrate assembly such that only an active portion of the chemically inert permeable membrane is exposed directly to the bulk gas mixture during use of the apparatus to measure hydrogen concentration. The apparatus further comprises evacuation means for substantially evacuating the housing, pressure means for measuring the pressure of the hydrogen gas diffusing through the membrane-substrate assembly into the housing, temperature control means for controlling temperature within the housing, bulk pressure means for measuring the pressure of the bulk gas mixture and bulk temperature means for measuring the temperature of the bulk gas mixture.

The method and apparatus of this invention are able to measure the concentration of hydrogen gas in any gas mixture except mixtures containing helium and mixtures containing neon gas. This is due to the fact that both helium and neon are very close in size to hydrogen and, thus, have membrane diffusion characteristics comparable to the membrane diffusion characteristics of hydrogen. Thus, it is also the case that the method and apparatus of this invention are suitable for measuring the concentration of helium in any gas mixture which does not include hydrogen and neon gases and for measuring the concentration of neon in a gas mixture which does not include hydrogen and helium, and such embodiments are deemed to be within the scope of this invention. For the purpose of simplicity, this invention will be described in terms of applicability to hydrogen gas, but it will be understood that wherever mention of hydrogen is made, helium or neon could be substituted therefor.

### BRIEF DESCRIPTION OF THE DRAWINGS

These and other objects and features of this invention will be better understood from the following detailed description taken in conjunction with the drawings wherein:

FIG. 1 is a cross-sectional lateral view of a hydrogen gas sensor for determining the concentration of hydrogen in a gas mixture in accordance with one embodiment of this invention in which the membrane-substrate assembly thereof is in a planar configuration;

FIG. 2 is a schematic diagram of a hydrogen gas sensor for determining the concentration of hydrogen in a gas mixture in accordance with another embodiment of this invention in which the membrane-substrate assembly thereof is in a tubular configuration;

FIG. 3a is a graphical representation of the diffusion of a single gas through a chemically inert membrane;

FIG. 3b is a graphical representation of the diffusion of a two component gas mixture in which one of the components is hydrogen;

FIG. 3c is an enlargement of the circled portions of FIGS. 3a and 3b;

FIG. 4 is a graphical representation of the hydrogen partial pressure on the side of the membrane-substrate assembly of the apparatus of this invention through which the hydrogen gas has diffused; and

FIG. 5 is a graphical representation showing the required relationship between the gas pressure in the membrane and the housing and the gas pressure of the bulk gas mixture at start-up of the measurement process.

### DETAILED DESCRIPTION OF THE PRESENTLY PREFERRED EMBODIMENTS

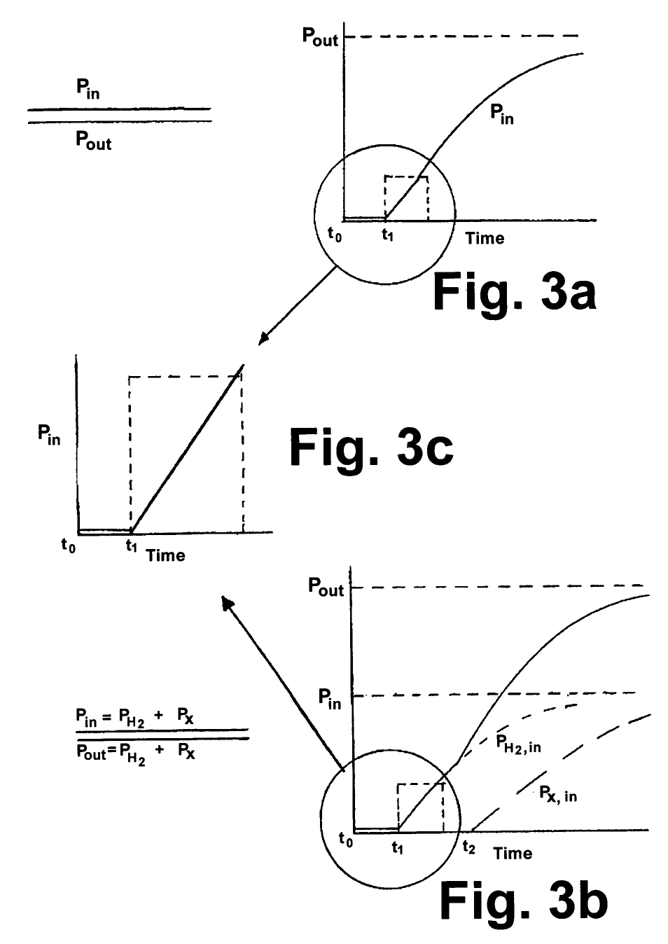

The invention claimed herein is a method and apparatus for measuring the concentration of hydrogen in a gas mixture that does not contain either helium or neon gas. The invention relies upon the permeability of gases by diffusion through inert membranes, which may be made of glass or many other materials. Suitable materials include, but are not limited to, VYCOR, NANOSIL and silica. Hydrogen has a higher permeability rate through such membranes compared to other gases (except helium and neon) and hydrogen permeates through such membranes faster than all other gases (except helium and neon). As used herein, the term “inert membranes” means membranes that are chemically inert. Permeation of gases through inert membranes is a highly predictable function of the thickness and properties of the membrane, the temperature of the membrane, the temperature and pressure of the bulk gas mixture, and the partial pressure difference of the diffusing gas between the two sides of the membrane. FIG. 3a shows that, for a single gas diffusing through an inert membrane, the shape of the curve is substantially exponential with the pressure on the inside of the membrane, Pᵢₙ, asymptotically approaching the bulk gas concentration (or pressure), Pₒᵤₜ. The time needed to reach equilibrium is a function of the physical properties of the system as mentioned.

FIG. 3b shows that for a two component gas mixture in the bulk gas, when one gas is hydrogen, hydrogen, H₂, will permeate through the membrane faster than the other gas, X. Both the single gas and two-component gas example assume there is no gas initially in the membrane or on the substrate side of the membrane-substrate assembly. The time in which hydrogen is the only gas diffusing through the membrane (time t₁ to t₂ in FIG. 3b) is a period of essentially linear increase (FIG. 3c) in hydrogen partial pressure on the substrate side of the membrane. This is true as long as hydrogen partial pressure in the bulk gas mixture is much greater than hydrogen pressure on the substrate side of the membrane. This property of hydrogen is unique to this gas and is unaffected by any other gas. The rate of increase in hydrogen partial pressure on the substrate side of the membrane measured before any other gas makes its way through the membrane (pressure increase vs. time) can be used to calculate hydrogen partial pressure in the bulk gas mixture using well understood diffusion equations.

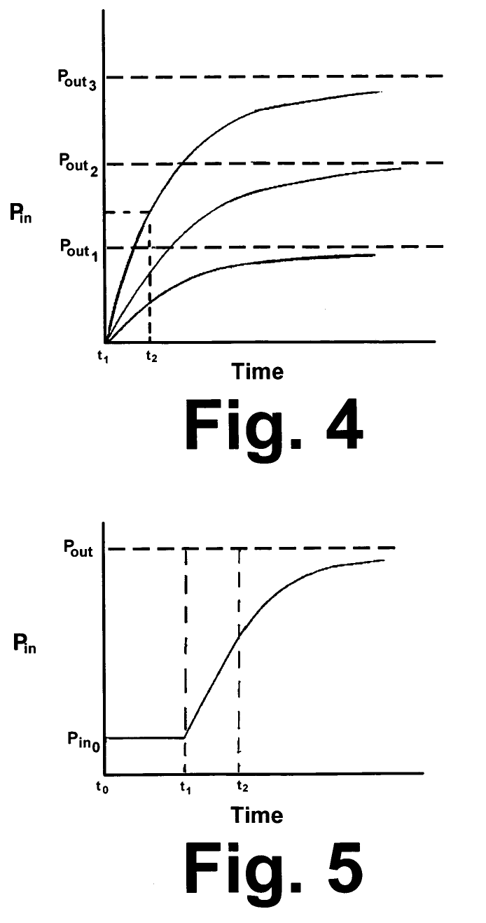

FIG. 4 shows that the rate of increase of hydrogen partial pressure on the substrate side of the membrane measured before any other gas passes completely through the membrane is a unique function of the hydrogen partial pressure in the bulk gas mixture. In practical operation, the membrane and the substrate side of the membrane cannot be evacuated to total vacuum before the sensor is used each time to measure hydrogen partial pressure in the bulk gas mixture. FIG. 5 shows that the pressure in the membrane and on the substrate side of the membrane must be well below the bulk gas pressure before the sensor is used, but the membrane pressure does not need to be reduced to a total vacuum. In practical operation, a pressure in the membrane and on the substrate side of the membrane in the range of about 0.001 to about 0.01 of the bulk gas pressure is expected to be sufficient for effective sensor operation.

As previously indicated, the method and apparatus of this invention use the unique property of hydrogen diffusion through an inert membrane at both a higher rate and faster than all other gases (with the noted exceptions of helium and neon). To accomplish this, the inert membrane must be thin, preferably in the range of about 0.1 microns to about 100 microns thick and most preferably in the range of about 1.0 microns to about 10 microns thick, and the diffusion properties of the membrane must be known for hydrogen and the other gases likely to be encountered in a bulk gas mixture. In addition, the membrane must be maintained at a constant temperature, typically by means of a suitable controlled heating source, and the temperature and pressure of the bulk gas mixture must be known. Yet a further requirement is that the membrane, in addition to being chemically inert, be stable. Stabilization is achieved in accordance with one embodiment of this invention by securing the membrane to a porous substrate of inert metal or ceramic material, forming a membrane-substrate assembly. The membrane is preferably bonded to the substrate and the two materials, i.e. the inert membrane and the substrate material, must have similar thermal expansion properties so that the membrane-substrate interface remains stable. Also required is a suitable means for accurately and quickly measuring either pressure or hydrogen partial pressure on the substrate side of the membrane.

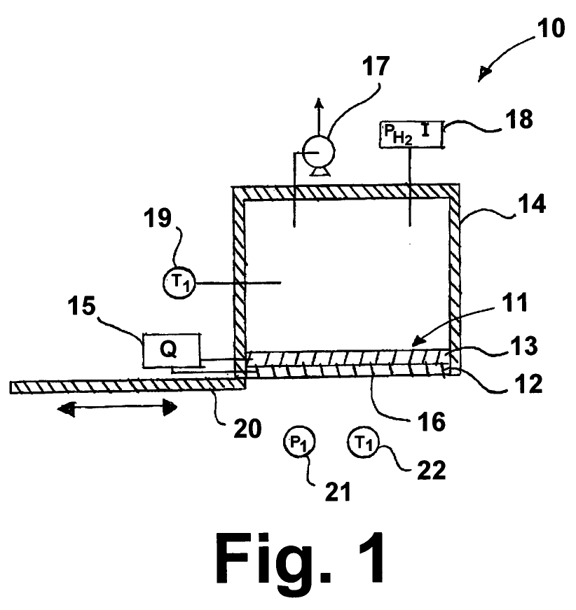

FIG. 1 is a diagram showing a planar configuration of a hydrogen sensor for measuring the concentration of hydrogen in a bulk gas mixture in accordance with one embodiment of this invention. As shown therein, hydrogen sensor 10 comprises membrane-substrate assembly 11, which comprises a chemically inert permeable membrane 12 having a membrane active area side 16 and a substrate material 13 secured to the side of membrane 12 opposite membrane active area side 16. Membrane-substrate assembly 11 is enclosed within an impermeable wall housing 14, whereby only the membrane active area side 16 of membrane-substrate assembly 11 is exposed to the hydrogen-containing bulk gas mixture during operation of the sensor. For those times when the sensor is not in use, a moveable, impermeable sensor seal plate 20 is provided for sealing membrane-substrate assembly 11 within impermeable wall housing 14, thereby isolating the sensor from the bulk gas.

As previously indicated, knowledge of the pressure and temperature of both the hydrogen gas diffusing through the membrane and the bulk gas mixture is required in order to carry out the method of this invention. Accordingly, sensor 10 further comprises a heater/temperature controller 15 adapted to control the membrane and substrate temperatures, at least one rapid hydrogen pressure indicator 18 adapted to measure the pressure of hydrogen diffused through membrane 12, at least one temperature indicator adapted to measure the temperature within housing 14, at least one bulk gas pressure indicator 21 adapted to measure the pressure of the bulk gas mixture, and at least one bulk gas temperature indicator 22 adapted to measure the temperature of the bulk gas mixture. Also as previously indicated, it is necessary to evacuate the housing between uses of the sensor. Accordingly, the sensor further comprises at least one vacuum pump 17 adapted to evacuate the housing 14 between uses of the sensor. Thus, when the membrane-substrate assembly is sealed from the bulk gas mixture by impermeable sensor seal plate 20, the vacuum pump 17 is used to reduce the pressure in the membrane-substrate assembly within the housing to a small absolute value relative to the bulk gas pressure, preferably in the range of about 0.001 to about 0.01 of the bulk gas pressure. When a bulk hydrogen concentration measurement is desired, the pump is shut off, and the sensor seal plate slid back to expose the membrane to the bulk gas.

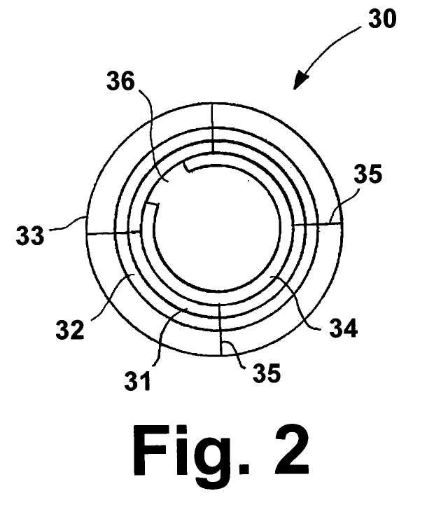

FIG. 2 shows an end view of a hydrogen sensor 30 without the end wall forming part of the impermeable wall housing, in accordance with another embodiment of this invention, having a tubular configuration. The sensor comprises an inert membrane 31 backed by a substrate material 32 to form a membrane-substrate assembly which, in turn, is enclosed within impermeable wall housing 33. The membrane-substrate assembly is further enclosed within housing 33 by a moveable arcuate sensor seal plate 34 having an opening 36 which provides fluid communication between the bulk gas mixture flowing through the center of the sensor during sensor operation and the active area of the membrane 31. In accordance with one preferred embodiment of this invention, the membrane-substrate assembly is divided by separator walls 35 into a plurality of arcuate sections. In that way, sections of the membrane-substrate assembly not in actual use can be evacuated while the active area of the assembly is in use.

In operation, when a hydrogen concentration determination is desired, the sensor seal plate covering the active area of the membrane is removed. Hydrogen partial pressure as a function of time data is collected from the time after hydrogen passes completely through the membrane and before other gases in the bulk gas begin to pass all the way through the membrane into the substrate. That is, after a time lag, t₁, for hydrogen to pass all the way through the membrane, pressure in the membrane-substrate assembly is measured several times before other gases diffuse completely through the membrane, t₂. This transient hydrogen partial pressure data (collected between time t₁ and t₂ as shown in FIG. 3B) is uniquely related to the partial pressure of hydrogen in the bulk gas. In other words, the slope of pressure versus time during the transient t₁ and t₂ period is a function of the partial pressure of hydrogen in the bulk gas and is not influenced by the type or concentration of any other species in the bulk gas. The rate of change of hydrogen pressure in the substrate between times t₁ and t₂ is directly related to the properties of the membrane, which, as previously indicated, must be known, to the membrane temperature, which must be known, to the bulk gas mixture temperature and pressure, which also must be known, and to the pressure of hydrogen in the bulk gas mixture.

After determination of the bulk gas mixture hydrogen partial pressure, the membrane-substrate assembly is isolated from the bulk gas, the pump (or other means) used to lower the membrane-substrate assembly pressure is turned on, and the cycle is repeated. To make regular and fast readings of bulk gas hydrogen partial pressure (or concentration), a plurality of membrane-substrate assemblies can be used. All other assemblies are evacuated while only one assembly is used to make hydrogen pressure determinations.

When measuring particularly low hydrogen concentrations, the sensor is dependent on a fast-responding and accurate pressure indicator. Thus, times t₁ and t₂ will typically both be less than one second with a difference of not more than half of a second. To obtain accurate determination of hydrogen concentrations as low as 1 ppm in the bulk gas, a pressure sensor must accurately read pressure to five orders of magnitude, at absolute pressures between 10⁻⁵ and 1 mTorr, up to five times, at intervals of 0.05 to 0.1 seconds. Several pressure sensors now exist that are capable of satisfying this demanding requirement. One such sensor is an absolute capacitive pressure sensor available from Integrated Sensing Systems, Inc. of Ypsilanti, Mich.

While in the foregoing specification this invention has been described in relation to certain preferred embodiments thereof, and many details have been set forth for the purpose of illustration, it will be apparent to those skilled in the art that the invention is susceptible to additional embodiments and that certain of the details described herein can be varied considerably without departing from the basic principles of this invention.

I claim:

1. An apparatus for measuring a concentration of a gas selected from the group consisting of hydrogen, helium and neon in a bulk gas mixture comprising said gas, the apparatus comprising:
a membrane-substrate assembly comprising a porous substrate material and a chemically inert permeable membrane having a gas diffusion rate higher than a remaining bulk gas mixture component diffusion rate secured to said porous substrate material;
at least one non-permeable wall forming a housing disposed around said membrane-substrate assembly whereby only an active portion of said chemically inert permeable membrane is exposed directly to said bulk gas mixture;
evacuation means for substantially evacuating said housing;
pressure means for measuring a pressure of said gas diffusing through said membrane-substrate assembly into said housing;
temperature control means for controlling temperature within said housing;
bulk pressure means for measuring a bulk pressure of said bulk gas mixture; and
bulk temperature means for measuring a bulk temperature of said bulk gas mixture.

2. An apparatus in accordance with claim 1, wherein said membrane-substrate is substantially planar.

3. An apparatus in accordance with claim 1, wherein said membrane-substrate assembly has a tubular configuration.

4. An apparatus in accordance with claim 1, wherein said chemically inert permeable membrane has a membrane thickness in a range of about 0.1 microns to about 100 microns.

5. An apparatus in accordance with claim 4, wherein said chemically inert permeable membrane has a membrane thickness in a range of about 1 micron to about 10 microns.

6. An apparatus in accordance with claim 1, wherein said porous substrate comprises at least one of a ceramic material and an inert metal.

7. An apparatus in accordance with claim 1, wherein said porous substrate has a substrate thickness in a range of about 0.1 microns to about 100 microns.

8. An apparatus in accordance with claim 1, wherein said chemically inert permeable membrane is made of at least one of glass and a ceramic material.

9 A method for determining a concentration of a gas selected from the group consisting of hydrogen, helium and neon in a bulk gas mixture comprising one of said gases and not the other of said gases, the method comprising the steps of:
sealing a membrane-substrate assembly in an impermeable wall housing, said membrane-substrate assembly comprising a porous substrate material and a chemically inert permeable membrane secured to said substrate material, said chemically inert permeable membrane having a gas diffusion rate higher than a remaining bulk gas mixture component diffusion rate;
measuring a bulk gas temperature and a bulk gas pressure of said bulk gas mixture;
evacuating an interior of said impermeable wall housing to an internal pressure in a range of about 0.001 to about 0.01 of said bulk gas pressure;
exposing only said chemically inert permeable membrane to said bulk gas mixture;
measuring a partial pressure of said gas diffusing through said membrane as a function of time for a period of time extending up to immediately prior to complete diffusion by a remaining bulk gas mixture component through said membrane;
measuring a membrane temperature of said membrane; and
determining a gas partial pressure of said gas in said bulk gas mixture.
